(19) United States
(12) Patent Application Publication
(10) Pub. No.: US 2006/0176995 A1
(43) Pub. Date: Aug. 10, 2006

(54) Control arrangement for use with nuclear fuel

(75) Inventor: Thomas J. Cahill, Litchfield Park, AZ (US)

Correspondence Address: Lowell W. Gresham;Meschkow & Gresham, P.L.C., Suite 409, 5727 North Seventh Street, Phoenix, AZ, 85014, US

(73) Assignee: Arizona Public Service Company

(21) Appl. No.: 11/056,891

(22) Filed: Feb. 10, 2005

(51) Int. Cl. G21C 7/00

(52) U.S. Cl. 376/327

(57) ABSTRACT

A control arrangement for use with nuclear fuel is configured as a control rod (32) for insertion into a guide tube (24) of a nuclear fuel assembly (20). The control rod (32) includes a housing (34) and solid ellipsoidal elements (44) of neutron absorber material loaded into a leading end (36) of the housing (34). The solid ellipsoidal elements (44) are generally solid spheres formed from a metal-based material. Alternatively, the housing of the control arrangement is the guide tube (24), and the solid ellipsoidal elements (44) are loaded into the guide tube (24) in preparation for spent fuel storage of the nuclear fuel assembly.

### TECHNICAL FIELD OF THE INVENTION

The present invention relates to the field of nuclear reactors. More specifically, the present invention relates to a control arrangement for controlling the reactivity of nuclear fuel through neutron absorption.

### BACKGROUND OF THE INVENTION

Nuclear reactors, such as pressurized-water nuclear reactors, include a vessel containing the reactor core which consists of fuel assemblies that are placed in adjacent arrangements, with their axes generally vertical. Typically, power output and power distribution is controlled in the reactor core with control rods, or pins, that can be inserted from the top of the reactor into the fuel assemblies. In addition, the control rods can be dropped into a position of maximum insertion in the reactor core to allow emergency shutdown of the nuclear reactor to take place.

FIG. 1 shows a partial perspective view of an upper portion of a prior art fuel assembly 20. Fuel assembly 20 includes a plurality of fuel rods 22 and a plurality of control rod guide tubes 24 retained by supporting lattices 26, of which only one is shown. A control rod cluster 28, which includes a number of control rods 30, is suspended above fuel assembly 20 and is operatively coupled to a control rod drive unit (not shown). Control rods 30 are inserted into guide tubes 24 or withdrawn from guide tubes 24 for adjusting or regulating reactor power.

Control rods 30 typically contain solid or tubular cylindrical pellets of a neutron absorbing material enclosed within a sealed tube (referred to as a “cladding tube”). One commonly utilized neutron absorbing material is boron carbide, B₄C. Boron carbide is a ceramic neutron absorbing material formed into small pellets and is typically stacked within the entire region of the control rod. Boron carbide pellets are subject to a large amount of swelling when they are irradiated in the reactor core. As the pellets swell in a radial direction, they can impart enough force against the cladding tube to cause clad deformation. Significant clad deformation can result in the control rod 30 jamming in its guide tube 24 during insertion or withdrawal. More critically, the cladding tube can crack due to the strain imposed from the swollen pellets. This problem is exacerbated at the lower end of control rod 30 which, by its location relative to fuel rods 22, incurs higher levels of irradiation than its upper end. Obviously, deformation and cracks in the cladding tube undesirably shortens the effective lifetime of the control rod. The undesirably short lifetime of control rods, caused by swelling of the neutron absorber, results in unplanned reactor shutdown and costly control rod replacements.

In an attempt to mitigate the problems associated with swollen boron carbide pellets, one prior art control rod employs boron carbide pellets with a slightly reduced diameter positioned at the lower end of control rod 30. The pellets are surrounded by a felt-like stainless steel mesh. The ceramic boron carbide degrades to a powder after long-term irradiation. The mesh is intended to prevent accumulation of the powder between the pellets and cladding tube, which might accelerate the strain transferred to the cladding tube from the swelling pellets. Despite the inclusion of stainless steel mesh, control rod failure can still occur thus leading to an undesirably short effective lifetime.

Other prior art designs utilize silver-indium-cadmium (AgInCd) tubing in the lower end of control rod 30 in place of the boron carbide. The upper region of control rod 30 may still include the boron carbide pellets. AgInCd serves as an adequate neutron absorber, although it is not as effective as boron carbide. However, there are some advantages in using the AgInCd tubing. In particular, AgInCd is not subject to the same failure mode as boron carbide because the rate of swelling is reduced and the alloy does not degrade to powder after being exposed to elevated neutron flux for an extended period of operation. Unfortunately, though, AgInCd is subject to a structural disfigurement referred to as “creep” which results from long-term exposure to high temperatures coincident with the structural compression forces imposed from the weight of the pellets above the AgInCd and from the control rod spring force. This creep effect will result in contact of the AgInCd material with the cladding tube after several cycles again imposing a strain in the cladding tube that can result in its failure.

Other control rod designs include a solid cylinder of AgInCd which is extruded to a length corresponding to the height of the reactor core. This extruded rod may be sealed within a cold-worked stainless steel tube so that the rod does not come into contact with the coolant. A problem with this design is the increased likelihood of warping (i.e. rod “bowing”) after long term operation. Still other solid control rod designs do not use a cladding tube and therefore avoid the principal issue of clad failure, although warping may still occur.

Thus, what is needed is an improved control rod that achieves lower levels of strain on the cladding tube and reduces the impact of material creep, therefore resulting in a longer effective lifetime.

### SUMMARY OF THE INVENTION

Accordingly, it is an advantage of the present invention that a control arrangement for a use with nuclear fuel is provided.

It is another advantage of the present invention that a control arrangement is provided that imparts reduced radial force against the cladding tube.

Yet another advantage of the present invention is that a control arrangement is provided that can be readily adapted to current designs without significantly increasing the fabrication cost, or decreasing the neutron absorbing properties, of conventional control arrangements.

The above and other advantages of the present invention are carried out in one form by a control arrangement for use with nuclear fuel. The control arrangement includes a housing and solid ellipsoid elements of neutron absorber material loaded into the housing.

The above and other advantages of the present invention are carried out in another form by a control arrangement for use with nuclear fuel. The control arrangement includes a cladding tube having opposing sealed ends, one of the ends being a leading end and the other of the ends being a trailing end upon insertion of the control arrangement into a fuel assembly. Solid spheres of neutron absorber material are contained in the cladding tube nearer to the leading end than to the trailing end.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a partial perspective view of an upper portion of a prior art fuel assembly;

FIG. 2 shows a vertical sectional view of a control rod in accordance with a preferred embodiment of the present invention;

FIG. 3 shows sectional view of the control rod of FIG. 2 across section lines 3-3;

FIG. 4 shows an enlarged partial vertical sectional view of a leading end of the control rod of FIG. 2; and

FIG. 5 shows an enlarged partial vertical sectional view of a leading end of a control rod in accordance with an alternative embodiment of the present invention.

### DETAILED DESCRIPTION OF THE PREFERRED EMBODIMENTS

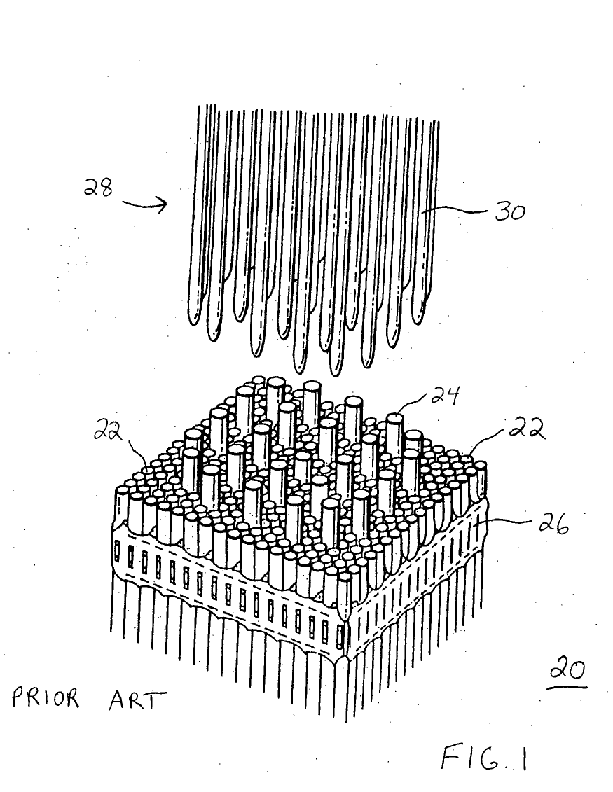

The present invention is a control arrangement for use with nuclear fuel of a nuclear reactor. The control arrangement is advantageously utilized with the existing guide tubes of a fuel assembly. Accordingly, the control arrangement may be utilized in place of control rods 30, discussed above. The control arrangement will be described in connection with fuel assembly 20 and guide tubes 24 of FIG. 1. However, it will become apparent that the configuration of the fuel assembly need not be limited to that shown in FIG. 1. Rather, the present invention may be adapted for use with a number of fuel assembly and control rod cluster configurations.

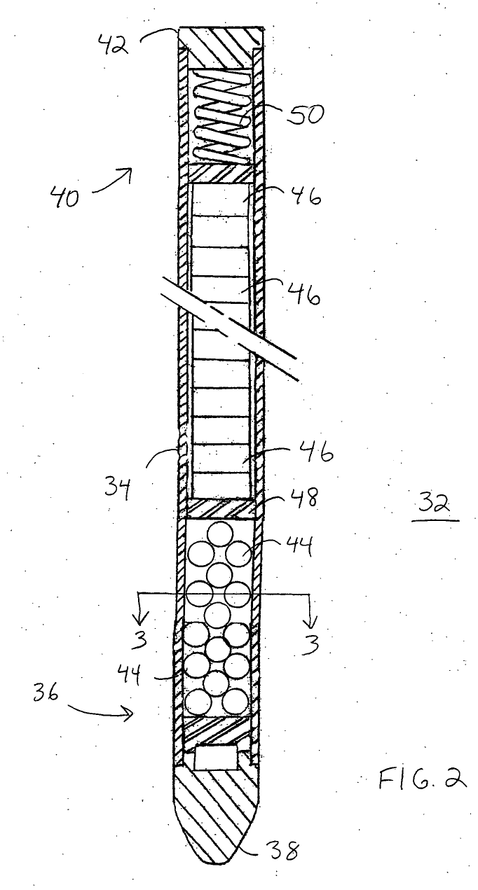

FIG. 2 shows a vertical sectional view of a control arrangement in accordance with a preferred embodiment of the present invention. In the embodiment of FIG. 2, control arrangement is configured as a control rod 32 for insertion into a guide tube, such as one of guide tubes 24 (FIG. 1). Control rod 32 includes a housing, in the form of a cladding tube 34, having a leading end 36 sealed by a first end plug 38, and an opposing trailing end 40 sealed by a second end plug 42. Leading end 36 denotes that portion of control rod 32 that first enters guide tube 24 when control rod 32 is inserted into guide tube 24.

Solid ellipsoid elements 44 of neutron absorber material are contained in cladding tube 34 nearer to leading end 36 than trailing end 40. Ellipsoid elements 44 may occupy an approximate depth of sixteen inches of cladding tube 34 at leading end 36, although it should be understood that any desired depth of elements 44 may occupy cladding tube 34. Neutron absorber pellets 46 are also contained in cladding tube 34 nearer to trailing end 40 than leading end 36. A separator, such as a stainless steel plug 48 is interposed between solid ellipsoid elements 44 and pellets 46, and a hold-down element 50 is interposed between second end plug 42 and the top-most one of neutron absorber pellets 46. Hold-down element 50 serves to prevent movement of the stack of solid ellipsoid elements 44 and pellets 46 during fabrication, shipping and handling. In addition, hold-down element 50 presses neutron absorber pellets 46 and solid ellipsoid elements 44 toward leading end 36, while allowing vertical movement of elements 44 and pellets 46 in response to radiation caused swelling. Typically, element 50 is a spring. However, those skilled in the art will recognize that alternative means may be employed to perform the functions of hold-down element 50.

The term “ellipsoid” refers to a surface whose plane sections are all ellipses or circles. The term “solid” refers a three dimensional figure bounded by a surface. Accordingly, solid ellipsoid elements 44 are three dimensional solid elements whose plane sections are all ellipses or circles. This is a deviation from the conventionally utilized tubular or cylindrical pellet-type neutron absorber material, having at least one plane section that is not an ellipse or a circle.

Solid ellipsoid elements 44 may have three axes each of different lengths, or may have two axes of the same length and one axis of a different length (i.e. a solid spheroid). However, in a preferred embodiment, solid ellipsoid elements 44 are solid spheres. That is, elements 44 have three axes all of equal lengths. Accordingly, for the remaining discussion, the ellipsoid elements will be referred to as solid spherical elements 44. The advantages of solid spherical elements 44 will be discussed below.

Solid spherical elements 44 are preferably formed from a metal-based material, such as an alloy or a pure metal, whereas neutron absorber pellets 46 may be formed from boron carbide. One exemplary metal-based alloy is silver-indium-cadmium (AgInCd). A metal-based material is preferred for elements 44 because it does not degrade to powder in response to prolonged exposure to and the high levels of radiation experienced at leading end 36. Nor does a metal-based material, such as AgInCd, swell as much as boron carbide. In a configuration in which solid spherical elements 44 are formed from pure metal, a collection of elements 44 can be made of different pure metals that are mixed together. This approach would introduce the option of altering the proportions of different neutron absorber materials used, which in turn, would enable additional flexibility when configuring control rods.

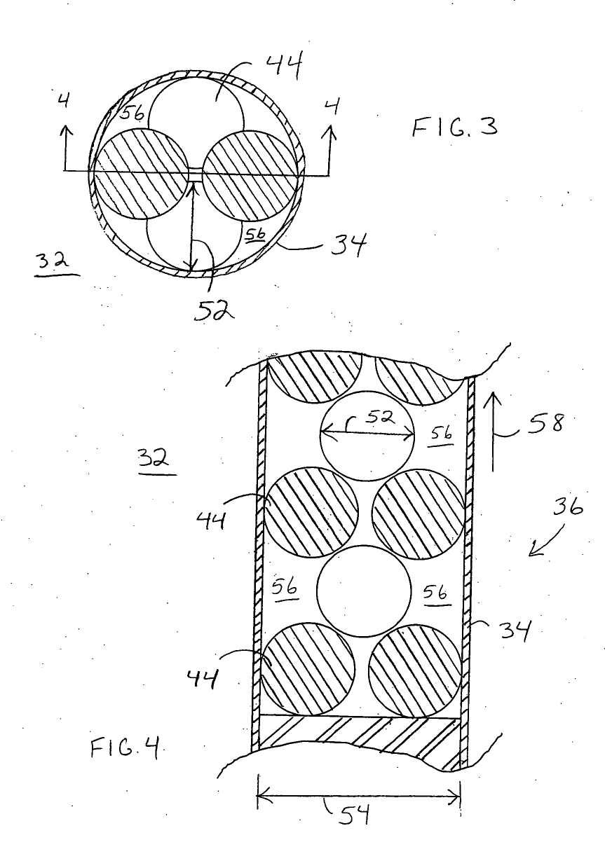

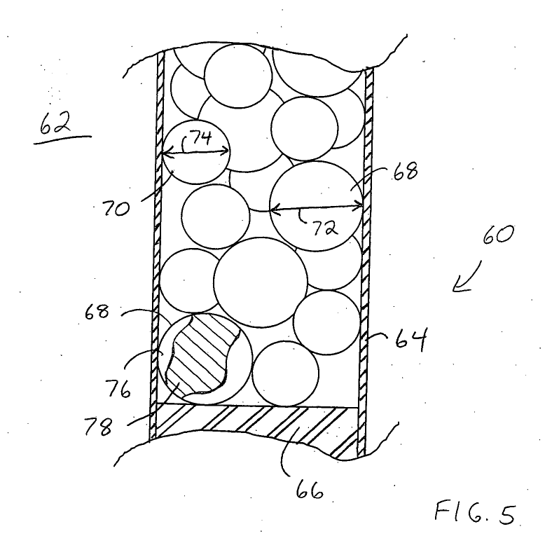

Referring to FIGS. 3-4, FIG. 3 shows a full sectional view of control rod 32 across section lines 3-3 of FIG. 2. FIG. 4 shows an enlarged partial vertical sectional view of leading end 36 of control rod 32 across section lines 4-4 of FIG. 3. Solid spherical elements 44 exhibit equivalent diameters 52. More clearly, elements 44 are generally all of the same size. In addition, when two of solid spherical elements 44 are aligned, diameters 52 are sized such that the two aligned elements 44 occupy 70-90% of a tube diameter 54 of cladding tube 34. As such, when solid spherical elements 44 are loaded into cladding tube 34 and shook or otherwise agitated in tube 34, solid spherical elements 44 will settle into an approximate nested position with pairs of aligned elements 44 in an alternating ninety degree stacked relationship. The spherical shape and paired alignment of elements 44 results in voids 56 in the interior of cladding tube 34.

Solid spherical elements 44 are not subject to the same radial swelling geometry as prior art cylindrical neutron absorber pellets. Rather, since elements 44 are ellipsoidal, and more particularly, spherical, each of elements 44 will swell in a generally uniform three dimensional radial direction. As a result, a collection of solid spherical elements 44 will transfer varied forces on one another within cladding tube 34 similar to the behavior of a “fluid”. Accordingly, when elements 44 swell, a small counter force from cladding tube 34 will cause elements 44 to volumetrically reconfigure in an axial direction, represented by an arrow 58, toward voids 56 within cladding tube 34. This reconfiguration in axial direction 58 is constrained only by hold-down element 50. Reconfiguration of solid spherical elements 44 in axial direction 58 results in a minimal force imposed on cladding tube 34, thereby greatly reducing the possibility of failure of cladding tube 34. In addition, this reconfiguration in axial direction 58 reduces the impact of material creep typically resulting from the elevated temperatures experienced by elements 44 during reactor operation combined with the force imposed from absorber pellets 46, plug 48, hold-down spring 50 and so forth onto solid spherical elements 44.

The approach of implementing control rods 32 containing solid spherical elements 44 is straightforward, hence cost effective, and is readily incorporated into existing designs, because the general characteristics of control rods 32 (i.e., materials, geometry, and control rod weight) are similar to current designs. In addition, the implementation of solid spherical elements 44 into control rods 32 can be readily varied to meet particular neutron absorption requirements. For example, it is not necessary to position solid spherical elements 44 in the base, i.e., at leading end 36, of cladding tube 34. Rather, the axial position of spherical elements can vary, by using elements 44 in place of neutron absorber pellets 46 at other locations throughout cladding tube 34, so as to adjust the neutron absorption characteristics of control rod 32. It may also be feasible to place other materials in the base of tube 34, with spherical elements 44 located above them.

Furthermore, it should be understood that implementation of solid spherical elements 44 need not be limited to their use with insertable control rods. Solid spherical elements 44 may also be utilized inside of stationary (i.e., non-moving) control rods (not shown) that may be installed within peripheral fuel assemblies of a reactor core. These stationary rods containing solid spherical elements 44 can be used to control the neutron flux outside of the core, which impacts metal welds present in a reactor pressure vessel.

Furthermore, control rods 32 containing solid spherical elements 44 may be utilized for partial insertion, for example, during MTC (moderator temperature coefficient) testing. The material composition of solid spherical elements 44 may be adjusted to improve power redistribution. For example, the sensitivity of control rods 32 containing elements 44 can be minimized to gain greater flexibility in support of reactor testing.

The use of solid spherical elements 44 as a neutron absorber introduces a potentially significant option with regard to long-term spent fuel storage. The storage criteria used for spent fuel is based on a maximum allowed nuclear reactivity associated with the spend fuel storage layout. Solid spherical elements 44 may be readily loaded directly into guide tubes 24 (FIG. 1) of fuel assembly 20 (FIG. 1). As such, guide tubes 24 would serve as a housing for containing elements 44. Once inserted, a plug or cap may be placed at the top of each of guide tubes 24 permanently sealing guide tubes 24 so that elements 44 are locked into tubes 24. The installation of elements 44 into guide tubes 24 represents a low cost solution for significantly reducing the nuclear reactivity characteristics of control rod assemblies allowing a more space-efficient storage layout. The improved storage density of spent fuel assemblies resulting from using the neutron absorber elements 44 could extend the length of time spent reactor fuel can remain in a storage pool before the capacity of the storage pool is reached.

FIG. 5 shows an enlarged partial vertical sectional view of a leading end 60 of a control rod 62 in accordance with an alternative embodiment of the present invention. Like control rod 32 (FIG. 2), control rod 62 includes a housing, in the form of a cladding tube 64, having leading end 60 sealed by a first end plug 66, and an opposing trailing end (not shown) sealed by a second end plug (not shown).

First solid spherical elements 68 of neutron absorber material and second solid spherical elements 70 of neutron absorber material are contained in cladding tube 64 near leading end 60. First solid spherical elements 68 exhibit a first diameter 72, and second solid spherical elements 70 exhibit a second diameter 74 that differs from first diameter 72. That is, spherical elements of two different sizes are loaded into cladding tube 64. Utilization of two or more different sizes of spherical elements, such as first and second elements 68 and 70, can yield a greater mass to volume ratio, thus greater capacity for neutron absorption.

It is theorized that the variation in the relative physical behavior among the ellipsoid elements, such as, first and solid spherical elements 68 and 70, as well as solid spherical elements 44, is likely to inhibit any long-term bonding. Such bonding may occur as a result of continued, long-term contact between the spherical elements at the elevated temperatures during operation. However, first and solid spherical elements 68 and 70, as well as solid spherical elements 44 (FIG. 2), may optionally be coated with a bond resistant layer 76 to further inhibit any potential for long-term bonding. As shown, one of first solid spherical elements 68 is illustrated with a portion of bond resistant layer 76 removed to reveal an underlying neutron absorber material 78.

One exemplary bond resistant layer 76 is nickel plating. Nickel plating involves the electrolytic deposition of nickel to form a corrosion barrier and wear resistant composite coating. However, the present invention need not be limited to the implementation of nickel plating to form bond resistant layer 74. Rather, those skilled in the art will recognize that other bond resistant materials, such as chromium, may perform equivalent functions to nickel plating.

In summary, the present invention teaches of a control arrangement for a use with nuclear fuel. The control arrangement may be realized as a cladding tube whose leading end is loaded with solid ellipsoid elements of a neutron absorber material. Alternatively, the control arrangement may be realized as a guide tube of a fuel assembly that is filled with the solid ellipsoid elements of neutron absorber material. As a control rod, the solid ellipsoid elements impart minimal radial force against the cladding tube thereby reducing the potential for cladding tube failure and increasing the effective lifetime. The approach of implementing control rods containing solid ellipsoidal elements can be readily adapted to current fuel assembly configurations without significantly increasing fabrication cost or decreasing the neutron absorbing properties because the general characteristics of the control rods are similar to current designs.

Although the preferred embodiments of the invention have been illustrated and described in detail, it will be readily apparent to those skilled in the art that various modifications may be made therein without departing from the spirit of the invention or from the scope of the appended claims. For example, control rod neutron absorption capability can be optimized for a particular use by varying the diameter, material properties, and bond resistant coating of the solid ellipsoid elements, as well as by varying the depth of the solid ellipsoid elements within the housing.

What is claimed is:

1. A control arrangement for use with nuclear fuel comprising:
a housing; and
solid ellipsoid elements of neutron absorber material loaded into said housing.

2. A control arrangement as claimed in claim 1 wherein said solid ellipsoid elements are solid spheres.

3. A control arrangement as claimed in claim 2 wherein said solid spheres exhibit equivalent diameters.

4. A control arrangement as claimed in claim 2 wherein said solid spheres are first solid spheres exhibiting a first diameter, and said control arrangement further comprises second solid spheres of neutron absorber material loaded into said housing, said second solid spheres exhibiting a second diameter, said second diameter differing from said first diameter.

5. A control arrangement as claimed in claim 2 wherein said housing is a tubular element exhibiting a tube diameter and two aligned ones of said solid spheres occupy 70-90% of said tube diameter.

6. A control arrangement as claimed in claim 1 wherein said neutron absorber material comprises a metal-based material.

7. A control arrangement as claimed in claim 1 wherein said solid ellipsoid elements are coated with a bond resistant material.

8. A control arrangement as claimed in claim 1 wherein said housing comprises a cladding tube having opposing sealed ends, one of said ends being a leading end and the other of said ends being a trailing end upon insertion of said control arrangement into a nuclear fuel assembly, and said solid ellipsoid elements are contained in said cladding tube nearer to said leading end than to said trailing end.

9. A control arrangement as claimed in claim 8 further comprising:
pellets of neutron absorber contained in said cladding tube nearer said trailing end than to said leading end; and
a separator located in said cladding tube and interposed between said solid ellipsoid elements and said pellets.

10. A control arrangement as claimed in claim 8 further comprising a hold-down element located in said cladding tube for pressing said solid ellipsoid elements toward said leading end.

11. A control arrangement as claimed in claim 1 wherein said control arrangement is a control rod for a control cluster of a nuclear reactor.

12. A control arrangement as claimed in claim 1 wherein said housing is a guide tube of a nuclear fuel assembly, and said solid ellipsoid elements are loaded into said guide tube in preparation for spent fuel storage of said nuclear fuel assembly.

13. A control arrangement for use with nuclear fuel comprising:
a cladding tube having opposing sealed ends, one of said ends being a leading end and the other of said ends being a trailing end upon insertion of said control arrangement into a fuel assembly; and
solid spheres of neutron absorber material contained in said cladding tube nearer to said leading end than to said trailing end.

14. A control arrangement as claimed in claim 13 wherein said solid spheres exhibit equivalent diameters.

15. A control arrangement as claimed in claim 13 wherein said cladding tube exhibits a tube diameter and two aligned ones of said solid spheres occupy 70-90% of said tube diameter.

16. A control arrangement as claimed in claim 13 further comprising:
pellets of neutron absorber contained in said cladding tube nearer to said trailing end than to said leading end; and
a separator located in said cladding tube and interposed between said solid ellipsoid elements and said pellets.

17. A control arrangement as claimed in claim 13 further comprising a hold-down element located in said cladding tube for pressing said solid spheres toward said leading end.

18. A control arrangement for use with nuclear fuel comprising:
a housing; and
solid spheres of neutron absorber material loaded into said housing, said neutron absorber material comprising a metal-based material.

19. A control arrangement as claimed in claim 18 wherein said housing comprises a cladding tube having opposing sealed ends, one of said ends being a leading end and the other of said ends being a trailing end upon insertion of said control arrangement into a fuel assembly, said solid spheres are contained in said cladding tube nearer to said leading end than to said trailing end, and said control arrangement yielding a control rod for a control cluster of a nuclear reactor.

20. A control arrangement as claimed in claim 18 wherein said housing is a guide tube of a nuclear fuel assembly, and said solid spheres are loaded into said guide tube in preparation for spent fuel storage of said nuclear fuel assembly.
